(19) United States
(12) Patent Application Publication
(10) Pub. No.: US 2024/0165866 A1
(43) Pub. Date: May 23, 2024

(54) METHOD FOR PRODUCING A STABILISER COMPOSITION FOR A POLYMER, AND STABILISER COMPOSITION PRODUCED USING SAID METHOD

(71) Applicant: Akdeniz Chemson Additives AG, Arnoldstein (AT)

(72) Inventors: Georg Andreas MEINHARDT, Arnoldstein (AT); Karl SCHULLER, Maria Elend (AT); Michael HECHER, Malenitzen (AT)

(73) Assignees: Akdeniz Chemson Additives AG, Arnoldstein (AT); Akdeniz Chemson Additives AG, Arnoldstein (AT)

(21) Appl. No.: 18/282,722

(22) PCT Filed: Jan. 24, 2022
(86) PCT No.: PCT/AT2022/060019

§ 371 Date: Sep. 18, 2023

(30) Foreign Application Priority Data
Mar. 19, 2021 (AT) A50189/2021

(51) Int. Cl. B29C 48/345; B29C 48/00; B29C 48/44; B29C 48/92; B29K 27/06; B29K 33/00

(52) U.S. Cl. CPC B29C 48/345; B29C 48/022; B29C 48/44; B29C 48/92; B29C 2948/92704; B29K 2027/06; B29K 2033/08

(57) ABSTRACT

A method for producing a stabilizer composition for a polymer, particularly a polymer containing halogen such as polyvinyl chloride, in which components for forming the stabilizer composition are mixed in an extruder and continuously discharged therefrom, in which an impact modifier is admixed. A correspondingly produced stabilizer composition and the use of a planetary roller extruder to produce a stabilizer composition.

The invention relates to a method for producing a stabilizer composition for a polymer, particularly a polymer containing halogen such as polyvinyl chloride, in which components for forming the stabilizer composition are mixed in an extruder and continuously discharged therefrom.

The invention also relates to a stabilizer composition.

Finally, the invention relates to the use of a planetary roller extruder.

Many polymeric plastics or polymers, such as polyvinyl chloride (PVC), have a diverse property profile and can be prone to thermal decomposition both when or during producing and during further processing, for example by extruding, calendering or injection molding. In addition, such polymers can also be subject to degradation after processing into a profile or the like in use, for example due to temperature influences or UV radiation. Therefore, it is necessary to admix processing aids and modifiers, or additives in general, for the purpose of processing and subsequent use, which are adapted to the processing and subsequent use.

PVC in particular can be provided as a dry blend for further processing into profiles such as window sills or other products. In addition to the plastic or PVC, a dry blend comprises the necessary additives, which can also be mixed into the dry blend in the form of a stabilizer composition with several additives.

It is convenient if a stabilizer composition for such purposes already comprises all the necessary components, so that no additive or other adjuvant needs to be admixed to the PVC in a separate step during processing. However, this is not always possible because different additives have different properties that make it difficult or impossible to satisfactorily process them into a component-comprehensive or final stabilizer composition.

For example, impact modifiers, especially those based on acrylates such as polybutyl acrylate, are difficult additives to incorporate into stabilizer compositions. Although the polybutyl acrylates can be admixed separately alongside other components in the producing of a dry blend, this requires a separate dosing unit or at least a separate dosing step. In addition, acrylates are tricky to handle due to the risk of dust explosions, because acrylates are basically very dusty. It would therefore be expedient to admix the acrylates, such as polybutyl acrylate, already during the producing of a stabilizer composition, so that in the subsequent producing of a dry blend the method step of separate admixture and thus also the associated potential hazard can be omitted. However, when stabilizer compositions are produced from the melt, the high viscosity means that the acrylates such as polybutyl acrylate are not dispersed, resulting in the formation of undesirable specks. If, alternatively, a powder mixture is prepared, i.e. if the individual components are processed without an intermediate molten state, formation of specks also occurs, but there is also the risk of segregation and thus of dusting and dust explosion.

It is the task of the invention to provide a method by which the above problems are eliminated or at least reduced.

Furthermore, it is an aim of the invention to disclose a stabilizer composition that can be used for polymers or dry blends for this purpose.

Another task is to specify a use of a planetary roller extruder.

The task according to the method is solved if an impact modifier is admixed in a method of the type mentioned above. In particular, this can be an acrylate that acts as an impact modifier, for example a polybutyl acrylate and/or another polymeric acrylate and/or an acrylate-containing co-polymer.

An impact modifier is any component capable of providing higher notched impact strength when mixed with a final polymer. Typically, this is also a polymer. By acrylate-containing impact modifiers in particular are meant polymers and copolymers containing acrylic monomers and/or acrylic monomer derivatives and/or combinations of acrylic monomer and acrylic monomer derivatives as monomer building blocks. For example, acrylic monomer derivatives include, but are not limited to: acrylate compounds, which may also comprise other elements such as nitrogen, sulfur or halogens, and/or functional groups such as aromatics, hydroxyls or cyano groups, for example methacrylate, methyl methacrylate, butyl acrylate, cyanoacrylate, acrylonitrile or hydroxyalkyl methacrylate.

In particular, the concept according to the invention is that an impact modifier such as an acrylate can be admixed during the producing of a stabilizer composition in an extruder from which extrusion is continuous, without causing speck formation or other adverse segregation. Due to a dust-free, homogeneous and effective dispersion of the impact modifier and the resulting good distribution of the same, a very good effect of the stabilizer composition is also achieved during subsequent application of the same. Due to this improved wringing, an amount of required impact modifier can also be minimized, which is a great advantage especially for difficult-to-handle materials such as acrylates. Moreover, subsequently, when the stabilizer composition is used for a dry blend or when processing a polymer such as PVC, there may be no need for separate dosing of an impact modifier. Since processing in an extruder is unproblematic, the risk of a dust explosion is thus not merely shifted to an upstream process step, but is in itself completely eliminated. We mentioned an aggregate such as polybutyl acrylate can be admixed as an impact modifier. Of course, other impact modifiers with similar problems can also be admixed accordingly.

It is particularly preferred that the impact modifier is admixed in the last third of the extruder during producing of the additive system, viewed in the downstream direction of extrusion. As a result, the impact modifier is processed only in a limited part of the extruder, namely the rear third, which is important in terms of a required but gentle exposure to shear. This is minimized area-wise, but is sufficient to ensure that the impact modifier is sufficiently incorporated. If the acting shear forces are low and/or only locally limited, however, an impact modifier such as a polybutyl acrylate or other acrylates is also prevented from gelling, which is a problem, for example, in the melting process mentioned at the beginning in the producing of stabilizers.

If an extruder with several sections arranged one after the other is used, it is useful for the impact modifier to be admixed in a final section. In particular, the individual sections can be directly connected to each other, but represent separate units that can be separately adjustable in terms of temperature and shear forces, as well as other process parameters. For the reasons explained previously, the impact modifier is then effectively prevented from gelling.

It may also be envisaged that extrusion is carried out with downstream decreasing shear forces. The shear forces can decrease continuously or even discretely. For a decrease in shear forces downstream, it is sufficient that at a single location the shear force decreases relative to the shear force at a location upstream previously in the extruder.

Although not mandatory, the impact modifier can also be admixed as the last component. The other components of the stabilizer composition are then already at least largely mixed and can then accommodate the impact modifier, for which a maximum volume is then available for distribution within the rest of the stabilizer composition, which is advantageous in order to prevent dust formation in the extruder itself as far as possible.

The stabilizer composition can be pelletized after exiting the extruder. In this process, the stabilizer composition can be pelletized under water. Alternatively, it is also possible, and for many applications also preferred, if the stabilizer composition is pelletized in air or with air or gas cooling, because the stabilizer composition may well comprise one or more water-soluble components, such as calcium acetylacetonate.

Since the stabilizer composition is extruded from the extruder essentially without pressure, it may be necessary for the stabilizer composition to be pressurized downstream of the extruder for efficient pelletizing. For this purpose, for example, the pressure can be generated with an appropriate pump, which pressurizes the stabilizer composition towards a perforated plate downstream of the extruder, so that the stabilizer composition meets the perforated plate under pressure, passes through it and is subsequently cut to pellet form.

A planetary roller extruder is particularly preferred as the extruder. With a planetary roller extruder, the shear forces can be specifically adjusted, which is favorable in terms of effective incorporation of the impact modifier and prevention of gel formation. In particular, a planetary roller extruder with several modules, preferably at least three modules, in particular four to eight modules, can be used. A planetary roller extruder with several modules has the advantage that the individual modules can be tempered separately, so that desired temperatures or temperature ranges can be set along the extruder depending on individual reactions or mixing processes and, if necessary, the release of water. Shear forces can also be varied in this case and thus adapted in the individual modules. The number of modules is preferably kept to match the stabilizer composition to be produced or the components required for this. In principle, the components are extruded in a temperature range from about 80° C. to 240° C. It is preferably provided that the temperature is initially adjusted increasing and subsequently decreasing downstream along the planetary roller extruder. A higher temperature at the beginning of the planetary roller extruder or extrusion process is required to partially melt the components to ensure intimate mixing.

Towards the end of the extrusion process, for example when a premix and/or temperature-sensitive pigments are admixed, the temperature is preferably lowered again. In this lowered range, the impact modifier is admixed as the last component, if necessary, so that it, too, is only subjected to a low temperature load.

It is further preferred that the shear forces in the planetary roller extruder are set to decrease downstream, in particular by reducing a number of planetary rollers in the planetary roller extruder downstream. This can be achieved in a simple way by providing a smaller number of planetary spindles in, for example, the last module of the planetary roller extruder than in the modules before. Also in this aspect, a planetary roller extruder is excellent for processing a stabilizer composition with an impact modifier.

If several modules are provided for a planetary roller extruder, typical temperature ranges can be selected according to Table 1 below.

TABLE 1
Temperature ranges of individual modules during the processing
of a stabilizer composition in a planetary roller extruder

| | Temperature range | Preferred temperature range |
|---|---|---|
| Module no. | [° C.] | [° C.] |
| 1 | 90 to 120 | 105 to 115 |
| 2 | 180 to 205 | 185 to 200 |
| 3 | 220 to 250 | 225 to 245 |
| 4 | 190 to 220 | 190 to 210 |
| 5 | 160 to 195 | 170 to 190 |
| 6 | 80 to 115 | 90 to 110 |
| 7 | 80 to 110 | 90 to 105 |

A stabilizer composition as produced by a method according to the invention is another aspect of the invention.

A stabilizer composition according to the invention is characterized in particular by the fact that an impact modifier, which in itself would only have to be admixed subsequently during the producing of a dry blend or a polymer product from PVC or another polymer, is already a component of the stabilizer composition and can be present homogeneously and in finely divided form.

The stabilizer composition is preferably free of heavy metals except for at most small amounts of zinc or zinc salts. In one embodiment, the stabilizer composition according to the invention does not contain lead apart from any impurities due to producing.

A stabilizer composition can in particular comprise the components described below, which are advantageously already mixed or in some cases reacted before the impact modifier during producing. Unless otherwise stated, percentages (%) refer to percent by weight.

The stabilizer composition according to the invention, in particular apart from a small amount of zinc, may be present, generally speaking, with one or more additives, such as primary stabilizers, co-stabilizers, zeolites, antioxidants, fillers, plasticizers, dyes, pigments, antistatic agents, surface-active agents, foam formation agents, (further) impact modifiers. UV stabilizers, lubricants, processing agents and/or the like.

Examples of stabilizers in general are epoxides and epoxidized fatty acid esters, phosphites, thiophosphites and thiophosphates, polyols, 1,3-dicarbonyl compounds, mercaptocarboxylic acid esters, dihydropyridines, antioxidants, light stabilizers and UV absorbers, alkali and alkaline earth compounds, perchlorate salts, zeolites, hydrotalcites or Dawson ite.

If not already included, other common additives, especially those for PVC, include lubricants, plasticizers, other impact modifiers, processing aids, blowing agents, fillers, antistatic agents, biocides, antifogging agents,

pigments and dyes, metal deactivators and flame retardants (see “Handbook of PVC Formulating” by E. J. Wickson, John Wiley & Sons, New York 1993) and may also be incorporated into the stabilizer composition.

Examples of components for or as stabilizers or additives are known to the skilled person (R. D. Maier, M. Schiller, Handbuch Kunststoff-Additive, 4th edition, Hanser Verlag, 2016). Below are some merely exemplary listings for such components.

Suitable phosphites, especially as co-stabilizers for chlorine-containing polymers, include trioctyl, tridecyl, tridodecyl, tritridecyl, tripentadecyl, trioleyl, tristearyl, triphenyl, tricresyl, tris-nonylphenyl, tris-2,4-t-butylphenyl or tricyclohexyl phosphite.

Various other phosphites such as differently mixed aryl-dialkyl or alkyldiaryl phosphites such as phenyldioctyl-, phenyldidecyl-, phenyldidodecyl-, phenylditridecyl, phenylditetradecyl-, phenyldipentadecyl-, octyldiphenyl-, decyldiphenyl-, undecyldiphenyl-, dodecyldiphenyl-, tridecyldiphenyl-, tetradecyldiphenyl-, pentadecyldiphenyl-, oleyldiphenyl-, stearyldiphenyl- and dodecyl-bis-2,4-di-t-butylphenyl-phosphite may also find use.

In addition, phosphites of various diols or polyols can also be advantageously used, for example, tetraphenyldipropylene glycol diphosphite, polydipropylene glycol phenyl phosphite, tetramethylolcyclohexanol decyl diphosphite, tetramethylolcyclohexanol-butoxyethyldiphosphite, tetramethylolcyclohexanol-nonylphenyldiphosphite, bis-Nonylphenyl-di-trimethylolpropandiphosphite, bis-2-butoxyethyl-di-trimethylolpropandiphosphite, trishydroxyethylisocyanurat-hexadecyltriphosphit, didecylpentaerythritdiphosphite, distearylpentaerythrtdiphosphite, bis-2,4-di-t-butylphenylpentaerythritdiphosphite. Mixtures of these phosphites and aryl/alkyl phosphite mixtures can also find application in a stabilizer composition according to the invention.

The organic phosphites can be applied in an amount of, for example, 0.01 to 10, advantageously 0.05 to 5, in particular 0.1 to 3 parts by weight, based on 100 parts by weight of polymer (e.g. PVC).

Examples of polyols that can be used include: pentaerythritol, dipentaerythritol, tripentaerythritol, bistrimethylolpropane, trimethylolethane, bistrimethylolethane, trimethylolpropane, sorbitol, maltitol, isomaltitol, lactitol, lycasin, mannitol, lactose, leucrose, tris-(hydroxyethyl)-isocyanurate, tetramethylolcyclohexanol (TMCH), tetramethylolcyclopentanol, tetramethylolcyclopyranol, glycerine, diglycerine, polyglycerine, thiodiglycerine, 1-0-a-D-glycopyranosyl-D-mannitol dihydrate, and polyvinyl alcohol and cyclodextrins. Preferred of these are TMCH and the disaccharide alcohols. The polyols can be applied in an amount of, for example, 0.01 to 20, advantageously 0.1 to 20, in particular 0.1 to 10, parts by weight, based on 100 parts by weight of polymer (e.g. PVC).

Thiophosphites or thiophosphates are compounds of the general type (RS)₃P, (RS)₃P=0 or (RS)₃P=S, respectively. Exemplary compounds are trithiohexylphosphite, trithiooctylphosphite, trithiolaurylphosphite, trithiobenzylphosphite, trithlophosphorous acid tris-[carboxy-i-octyloxy]methyl ester, trithiophosphoric acid S,S,S-tis-[carbo-i-octyloxy]methyl ester, trithiophosphoric acid S,S,S-tris-[carbo-2-ethylhexyloxy]-methyl ester, trithiophosphoric acid-S,S,S-tris-1-[carbo-hexyloxy]-ethyl ester, trithiophosphoric acid-S,S,S-tris-1-[carbo-2-ethylhexyloxy]-ethyl ester, trithiophosphoric acid-S,S,S-tris-2-[carbo-2-ethyl hexyloxyethyl ester. The thiophosphites or thiophosphates can suitably be present at 0.01% to 20%, preferably at 0.1% to 5%, in particular at 0.1% to 1% in the polymer (e.g. PVC), which in particular contains chlorine.

Examples of 1,3-dicarbonyl compounds are acetylacetone, butanoylacetone, heptanoylacetone, stearoylacetone, palmitoylacetone, lauroylacetone, 7-tert-nonylthioheptanedione-2,4, benzoylacetone, dibenzoylmethane, lauroylbenzoylmethane, palmitoylbenzoylmethane, stearoylbenzoylmethane, isooctylbenzoylmethane, 5-hydroxycapronyl—benzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, 1-benzoyl-1-acetylnonane, benzoyl-acetyl-phenylmethane, stearoyl-4-methoxy-benzoylmethane, bis(4-tert-butylbenzoyl)methane, benzoyl-formylmethane, benzoyl-phenylacetylmethane, bis(cyclohexanoyl)methane,

Di(pivaloyl)methane, acetoacetic acid methyl ester, ethyl ester, hexyl ester, octyl ester, dodecyl ester or octadecyl ester, benzoylacetic acid ethyl ester, butyl ester, −2-ethylhexyl ester, —dodecyl or—octadecyl ester, stearoylacetic acid ethyl, propyl, butyl, hexyl or octyl ester and dehydroacetic acid as well as their zinc, alkali metal, alkaline earth metal and/or aluminum salts. The 1,3-dicarbonyl compounds can be applied in an amount of, for example, 0.01 to 10, advantageously 0.01 to 3, in particular 0.01 to 2, parts by weight, based on 100 parts by weight of polymer (e.g. PVC).

Examples of mercaptocarboxylic acid esters include: esters of thioglycolic acid, thio malic acid, mercaptopropionic acid, mercaptobenzoic acids or thiolactic acid as described for example in EP 0 365 483 A1.

The mercaptocarboxylic acid esters also comprise corresponding polyol esters or their partial esters. The corresponding esters can suitably be present at 0.01% to 10%, preferably at 0.1% to 5%, in particular at 0.1% to 1% in a polymer, in particular one containing chlorine.

A stabilizer composition according to the invention may additionally comprise at least one epoxidized fatty acid ester. Esters of fatty acids from natural sources, such as soybean oil or canola oil, are preferred. The epoxy compounds are applied in amounts of, for example, from 0.1 parts, based on 100 parts by weight of composition, expediently from 0.1 to 30, in particular from 0.5 up to 25, parts by weight. Other examples include epoxidized polybutadiene, epoxidized flaxseed oil, epoxidized fish oil, epoxidized tallow, methyl butyl or 2-ethylhexyl epoxystearate, tris(epoxypropyl) isocyanurate, epoxidized castor oil, epoxidized sunflower oil, 3-phenoxy-1.2-epoxypropane, bisphenol A diglycidyl ether, vinyl cyclohexene diepoxide, and/or dicyclopentadiene diepoxide. Bisphenol A and bisphenol F derivatives can also be used as epoxides.

Furthermore, monomeric dihydropyridines and/or polydihydropyridines can be provided as stabilizers as disclosed in EP 0 796 888 A2. The (poly)di-hydropyridines can conveniently be applied in the particularly chlorine-containing polymer at 0.001 to 5, in particular 0.005 to 1, parts by weight, based on the polymer at 100 parts by weight.

Furthermore, sterically hindered amines can be provided as stabilizers, as also disclosed in EP 0 796 888 A2.

A stabilizer composition according to the invention may contain alkali and alkaline earth compounds, in particular the carboxylates of the acids described above, but also corresponding oxides or hydroxides, carbonates or basic carbonates. Their mixtures with organic acids are also possible. Examples include NaOH, KOH, CaO, Ca(OH)₂, MgO, Mg(OH)₂, CaCO₃, MgCO₃, dolomite, zinc oxide, zinc carbonate, and fatty acid Na, K, Ca, Mg, or Zn salts. In the case of alkaline earth and Zn carboxylates, their adducts with MO or M(OH)₂ (M=Ca, Mg, Sr or Zn), so-called ‘overbased’ compounds, can also be used. Preferably, alkali metal, alkaline earth metal and/or aluminum carboxylates are additionally used in a stabilizer according to the invention, for example sodium, potassium, calcium or aluminum stearates.

For example, the stabilizer composition may comprise one or more perchlorate salts, such as those of the general formula M(CIO4)n, where M is Li, Na, K, Mg, Ca, Ba, Zn, Al, Ce, or La. The index n runs from 1 to 3 according to the valence of M and is thus 1, 2 or 3. The perchlorate salts may be complexed with alcohols or ether alcohols. The perchlorate in question can be used in various common dosage forms, e.g. as a salt or aqueous solution drawn up on a carrier material such as PVC, Ca-silicate, zeolites or hydrotalcite, or obtained by chemical reaction of hydrotalcite with perchloric acid. Alternatively or additionally, layered silicates intercalated with perchlorate, such as hydrotalcites, can also be used. Exemplary compounds of this group are Alcamizer®-products of Kisuma Chemicals. The perchlorates can be applied in an amount of, for example, 0.001 to 5, expediently 0.01 to 3, particularly preferably 0.01 to 2, parts by weight, based on 100 parts by weight of PVC or other polymer.

Co-stabilizers are compounds that can provide a further stabilizing contribution to polymers containing halogen. Possible co-stabilizers can be selected from the group consisting of 1,3-diketone compounds, polyols, metal salts, natural or synthetic minerals such as hydrotalcites, hydrocalumites and zeolites, amino acid derivatives, organic esters of phosphorous acid, epoxy compounds.

Examples of 1,3-diketone compounds comprise, but are not limited to, dibenzoylmethane, stearoylbenzoylmethane, palmitoylbenzoylmethane, myristoylbenzoylmethane, lauroylbenzoylmethane, benzoylacetone, acetylacetone, tri-benzoylmethane, diacetylacetobenzene, p-methoxystearoylacetophenone, acetoacetic acid ester and acetylacetone, and their metal salts, in particular those of lithium, sodium, potassium, calcium, magnesium, titanium and/or aluminum.

Co-stabilizers from the group of polyols comprise, but are not limited to, glycerol, pentaerythrtol, di- and tripentaerythritol, trismethylolpropane (TMP), di-TMP, sorbitol, mannitol, maltitol, saccharides, disaccharides (especially sucrose, 4-O-ß-D-galactopyranosyl-D-glucose, 4-0-alpha-D-glucopyranosyl-D-glucose, 6-0-(6-deoxy-alpha-L-mannopyranosyl)-D-glucose, alpha-D-glucopyranosyl-alpha-D-glucopyranoside, 6-O-alpha-D-glucopyranosyl-D-glucose, 4-O-ß-D-glucopyranosyl-D-glucose, 2-0-ß-D-glucopyranosyl-D-glucose, 6-O-alpha-D-glucopyranosyl-D-glucitol, 3-0-alpha-D-glucopyranosyl-D-fructose, 6-O-ß-D-glucopyranosyl-D-glucose, 4-O-ß-D-galactopyranosyl-D-glucitol, 4-O-alpha-D-Glucopyranosyl-D-glucitol, 6-O-alpha-D-galactopyranosyl-D-glucose, 3-O-alpha-D-galactopyranosyl-ß-D-myo-inositol, 4-O-ß-D-galactopyranosyl-D-fructose, 4-O-ß-D-galactopyranosyl-ß-D-glucopyranose, ß-O-alpha-D-glucopyranosyl-D-fructose, 4-0-ß-D-galactopyranosyl-alpha-D-glucopyranose, 2-0-(6-Deoxy-alpha-L-mannopyranosyl)-D-glucose, 4-O-alpha-D-glucopyranosyl-D-fructose, 2-O-ß-D-glucopyranosyl-alpha-D-glucopyranose, 1-0-alpha-D-glucopyranosyl-D-mannitol, 6-0-(6-deoxy-alpha-L-mannopyranosyl)-ß-D-glucopyranose, 2-0-ß-D-glucopyranosyl-ß-D-glucopyranose, 6-0-alpha-D-glucopyranosyl-alpha-D-glucopyranose, 2-O-alpha-D-glucopyranosyl-alpha-D-glucopyranose, 2-O-alpha-D-glucopyranosyl-ß-D-glucopyranose, 1-O-alpha-D-glucopyranosyl-D-fructose, 6-0-alpha-D-glucopyranosyl-alpha-D-fructofuranose, 6-0-alpha-D-glucopyranosyl-D-glucitol, 4-O-ß-D-galactopyranosyl-D-glucitol, 4-0-alpha-D-glucopyranosyl-D-glucitol, 1-0-alpha-D-glucopyranosyl-D-mannitol, trisaccharides, polysaccharides, in particular polyvinyl alcohols, starch, cellulose and their partial esters.

Examples of antioxidants comprise, but are not limited to, alkylphenols, hydroxyphenylpropionates, hydroxybenzyl compounds, alkylidene bisphenols, thiobisphenols, and aminophenols, in particular e.g. 2,6-di-tert-butyl-4-methyl-phenol, 2,6-di-benzyl-4-methyl-phenol, stearyl-3-(3′-5′-di-tert.-butyl-4′-hydroxy-phenyl)propionate, 4,4′-thiobis-(3-methyl-6-tert.-butyl-phenol), 4-nonylphenol, 2,2′-methylenebis(4-methyl-6-tert.-butylphenol), 2,5-di-tert. butylhydroquinone, 4,4′,4″-(1-methyl-I-propanyl-3-ylidene)tris [2-(1,1-dimethylethyl)-5-methyl-phenol], their neutral or basic lithium, magnesium, calcium and aluminum salts, and sterically hindered amines and/or phosphonites and mixtures thereof.

Examples of co-stabilizers from the group of metal salts include, but are not limited to, hydroxides, oxides, carbonates, basic carbonates, and carboxylic acid salts of lithium, sodium, potassium, magnesium, calcium, aluminum, titanium, and the like, as long as (excluding zinc) no heavy metal is used. In one embodiment of the present invention, the metal salts may be salts of higher carboxylic acids, for example C₆-C₂₂ carboxylic acids, such as stearic, palmitic, myristic, lauric, oleic, oleic and ricinoleic acids.

Examples of natural and synthetic minerals include, but are not limited to, A3, A4, A5 zeolites, mordenite, erionite, faujasite X or Y type zeolites, and ZSM-5 zeolites, hydrotalcites (of Alcamizer®1 and 4 type) and/or mixtures thereof.

Mesoporous materials, in particular mesoporous silicates such as MCM-41 or SBA-15, can also be components of a stabilizer composition according to the invention.

Examples of co-stabilizers from the group of amino acid derivatives comprise, but are not limited to, glycine, alanine, lysine, tryptophan, acetylmethionine, pyrrolidonecarboxylic acid, a-aminocrotonic acid, a-aminoacrylic acid, a-aminoadipic acid and the like, and the corresponding esters thereof. The alcohol components of these esters may comprise monohydric alcohols, such as methyl alcohol, ethyl alcohol, propyl alcohol, i-propyl alcohol, butyl alcohol, a-ethyl hexanol, octyl alcohol, i-octyl alcohol, lauryl alcohol, stearyl alcohol and the like, and polyols, such as ethylene glycol, propylene glycol, 1,3-butanediol, 1,4-butanediol, glycerol, digylcerol, trismethylolpropane, pentaerythritol, dipentaerythritol, erythritol, sorbitol, mannitol and the like.

Examples of co-stabilizers from the phosphorous acid ester group include, but are not limited to, triarylphosphites, such as triphenylphosphite, tris(p-nonylphenyl)phosphite, alkylarylphosphites, such as monoalkyldiphenylphosphites, such as diphenylisooctylphosphite, diphenylisodecylphosphite, and dialkylmonophenylphosphites, such as phenyldiisooctylphosphite or phenyl-diisodecylphosphite, and trialkylphosphites such as triisooctyl-phosphite, tristearylphosphite and the like.

Another component which can be admixed to the stabilizer composition of the invention is titanium dioxide. Titanium dioxide essentially occurs in nature in three modifications: Anatas, Brookit and Rutile. Both anatase and as rutile have technical importance as a pigment. The high refractive indices of 2.55 (anatase) and 2.75 (rutile) justify the brightening and hiding power and thus the use as white pigment. Rutile completely absorbs light below 400 nm, i.e. the entire UV range, when dosed appropriately. The absorption of anatase is somewhat shifted towards shorter wavelengths. Brookite, on the other hand, shows no photocatalytic activity and is therefore not preferred as a further component of the stabilizer composition, but can be added as a filler.

For outdoor applications, the titanium dioxide advantageously has rutile structure. For all other applications, it can have both anatase and rutile structure. Combinations of these modifications are also possible.

According to the invention, the titanium dioxide can be used in an amount of about 0.01% to about 20% in the stabilizer composition. In another embodiment, the titanium dioxide may be used in an amount from about 0.05% to about 10.0% or from about 0.1% to about 5%, for example in an amount of about 4%. The titanium dioxide should be finely dispersed and well dispersed.

Paraffin wax may be used as an exemplary lubricant. In one embodiment, the paraffin wax may be a mixture of alkanes having the general molecular formula CₙH2n+2, where n is an integer from 20 to 100. The mixture can consist of both straight-chain and non-straight-chain components as well as purely straight-chain components. Examples of commercially available and usable paraffin waxes comprise, but are not limited to, Fischer-Tropsch paraffins and related compounds.

Fillers may be provided as a component of a stabilizer composition, but are not necessarily a component thereof.

The other co-stabilizers listed above can be used in quantities identical to the lubricants.

To process polymers containing halogen with the stabilizer composition produced according to the invention, the methods known in the prior art can be used. Examples of such methods include, but are not limited to, calendering, extruding, injection molding, blow molding, and the like. The composition according to the invention can also be admixed to a dry blend, which is subsequently further processed into a product that is at least close to final dimensions.

Polymers produced with the stabilizer composition according to the invention can be produced into products for various applications. For example, the appropriately stabilized polymers can be used to produce window profiles, pipes, flooring, roofing membranes, cables and films. The polymers can also be foamed or foamed during processing. In addition, to name just a few examples, the polymers can be used in materials for recreational boats, rotor blades for wind turbines and in railcar construction. All these applications are only examples without limiting in any way the use of a stabilizer composition according to the invention.

The task of indicating the use of a planetary roller extruder is solved when a planetary roller extruder is used to produce a stabilizer composition, wherein shear forces are adjusted via a different number of planetary spindles in modules of the planetary roller extruder.

The advantage of such a use is that otherwise stabilizer compositions of high quality can be provided which are difficult or impossible to produce and have inadequate quality properties. In particular, if the individual modules can also be tempered separately, the conditions for mixing, possibly with simultaneous running of a reaction, can be optimized.

Further features, advantages and effects of the invention will be apparent from the examples of embodiments set forth below. In the drawing the following is shown:

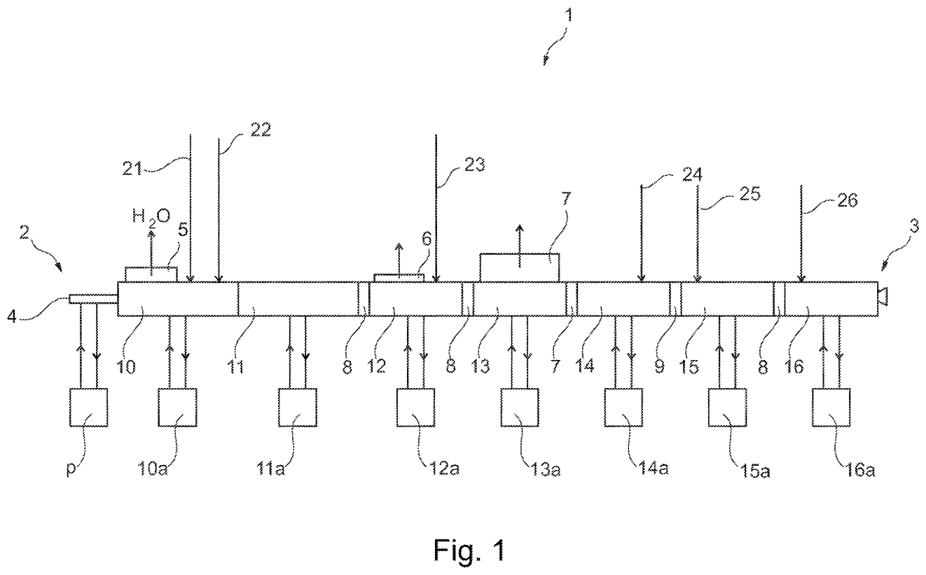

FIG. 1 a planetary roller extruder.

FIG. 1 shows an extruder which is used in the processing or producing of a stabilizer composition according to the invention. The extruder is a planetary roller extruder 1.

The planetary roller extruder has a first end 2 and a second end 3 opposite the first end 2. The planetary roller extruder 1 is composed of several modules 10, 11, 12, 13, 14, 15, 16. Each of these modules 10, 11, 12, 13, 14, 15, 16, is respectively equipped with a circuit 10a, 11a, 12a, 13a, 14a, 15a, 16 with heating and/or cooling function. A fluid, in particular an oil, can be circulated in these circuits 10a, 11a, 12a, 13a, 14a, 15a, 16a to bring the individual modules 10, 11, 12, 13, 14, 15, 16 to a desired temperature or to maintain them at this temperature during a processing of a composition. If necessary, temperature changes can also be carried out. A similar circuit p is provided for temperature control of a spindle 4.

A spindle 4 of the planetary roller extruder 1 passes through the modules 10, 11, 12, 13, 14, 15, 16. The spindle 4 is the central drive element. On the outside, the spindle 4 is surrounded by a plurality of planetary spindles which are not visible, as is usual for a planetary roller extruder 1. The number of planetary spindles arranged around the spindle 4 within the modules 10, 11, 12, 13, 14, 15, 16 can be varied for the individual modules 10, 11, 12, 13, 14, 15, 16. Typically, three, five or seven planetary spindles are provided in each module 10, 11, 12, 13, 14, 15, 16. Furthermore, the planetary roller extruder 1 may comprise dispersing disks 8 between individual modules 10, 11, 12, 13, 14, 15, 16 and a degassing disk 9 downstream.

The spindle 4 is connected to a motor, not shown, which can set the spindle 4 in rotary motion. In this case, the spindle 4 runs at a freely selectable rotational speed, e.g. typically at rotational speeds between 200 rpm to 400 rpm with an inner diameter of the extruder of 100 mm to 120 mm and a diameter of a central spindle of 70 mm to 75 mm. Rotational speeds in the range of about 275 rpm to 375 rpm have proved particularly suitable for the extruder dimensions given as examples. By means of the rotational speed on the one hand and a number of planetary spindles arranged around spindle 4 on the other, shear forces in modules 10, 11, 12, 13, 14, 15, 16 can be adjusted, which makes it possible, as will be explained below, to create stabilizer compositions that are otherwise impossible to produce or can be produced only with unsatisfactory results.

The planetary roller extruder 1 according to FIG. 1 further has several outlets 5, 6, 7. Outlets 5, 6, 7 need not be provided, but are convenient and useful when a stabilizer composition is processed which tends to heavy foam formation during processing. This is the case, for example, when stabilizer compositions are processed with fatty acids or derivatives, whereby water is released during their reaction. The outlets 5, 6, 7, which are arranged on an upper side of the housing of the individual modules 10, 11, 12, 13, 14, 15, 16 of the planetary roller extruder 1, are preferably rectangular in cross-section. In particular, the outlets may be cuboidal or slit-shaped outlets 5, 6, 7 extending upwards, through which controlled foaming with water discharge is possible without the stabilizer composition to be processed escaping. Rather, only an escape of water occurs while the stabilizer composition to be processed is propelled forward by spindle 4 in cooperation with the associated planetary spindles downstream toward the second end 3.

For the producing of a stabilizer composition, the planetary roller extruder 1 must be fed in a suitable manner. Individual feeders 21, 22, 23, 24, 25, 26 can be provided for this purpose. In the corresponding feeders 21, 22, 23, 24, 25, 26, the feeding of individual components for the producing of the stabilizer composition takes place, and a feed can be adjusted with respect to the temperature of the modules 10, 11, 12, 13, 14, 15, 16, shear forces and degree of homogenization of the stabilizer components.

In the producing of a stabilizer composition, the individual modules 10, 11, 12, 13, 14, 15, 16 are separately tempered via circuits 10a, 11a, 12a, 13a, 14a, 15a, 16a. Table 2 below lists typical temperatures for individual modules in the producing of a stabilizer composition, where the stabilizer composition is prepared with an impact modifier. The temperature of the melt pump refers to a pump downstream of the extruder for pressurizing the discharged stabilizer composition.

TABLE 2
Circuit temperatures of individual modules

| | Module | | | | | | | | Melt |
|---|---|---|---|---|---|---|---|---|---|
| | P | 10 | 11 | 12 | 13 | 14 | 15 | 16 | Pump |
| Circuit | 100 | 110 | 190 | 240 | 200 | 180 | 120 | 120 | 90 |
| temperature [° C.] | | | | | | | | | |

In the producing of a stabilizer composition with an impact modifier in a planetary roller extruder 1, the individual components for the stabilizer composition are initially fed into one or more of the feeders 21, 22, 23, 24, 25, but not the impact modifier. Table 3 below shows a corresponding composition with a premix according to Table 4. Modules 10, 11, 12, 13, 14, but not module 16, are each operated with five planetary spindles. A typical rotational speed of spindle 4 is 300 rpm. Module 16 and optionally Module 15 are operated with only three planetary spindles. A premix containing an impact modifier such as an acrylate, in particular polybutyl acrylate, is fed into modules 15, 16 via feeder 25 and/or feeder 26. The composition of the premix is shown in Table 4 below, as mentioned.

TABLE 3
Exemplary composition for a stabilizer composition related
to 1000 kg output (10.7 kg escaping residual water taken
into account, all bases react off with the acids)

| | Component | Amount [kg] |
|---|---|---|
| 1 | Catalyst, e.g. acetic acid | 0.5 |
| 2 | fatty acids (mix of hydroxystearic acid, | 325.19 |
| | stearic acid) | |
| 3 | Bases (mix of calcium hydroxide, zinc oxide | 46.22 |
| | and magnesium hydroxide) | |
| 4 | Co-stabilizer (dehydracetic acid) | 13.71 |
| 5 | Premix according to Table 4 | 625.10 |
| | Subtotal | 1010.72 |
| | Reaction water (escapes during the process) | −10.72 |
| | Total | 1000.00 |

TABLE 4
Composition of a premix (see Table 3)
based on 1000 kg stabilizer composition

| | Component | Amount [kg] |
|---|---|---|
| A | Filler (chalk) | 46.40 |
| B | Organic co-stabilizers 1 | 49.70 |
| | (stearoylbenzoylmethane, calcium acetylacetonate, | |
| | zinc acetylacetonate) | |
| C | Organic co-stabilizers 2 | 68.60 |
| | (T rishydroxyethylisocyanurate) | |
| D | Inorganic co-stabilizers (hydrotalcite, zeolite, | 166.70 |
| | magnesium hydroxide) | |
| E | Lubricant (ethylene glycoldipalmitate, | 120.60 |
| | polyethylene wax homopolymer. FT paraffin) | |
| F | Antioxidant (octa-decyl-3-[3,5-di-tert-butyl-4- | 24.70 |
| | hydroxyphenyl]propionate]) | |
| G | Pigments | 11.80 |
| H | Impact modifier (Akdeniz DMA 650) | 136.60 |
| | Total | 625.10 |

Components 1 to 4 of the stabilizer composition other than the premix can be fed into modules 10, 11, 12, in particular stearic acid. Hydroxystearic acid, zinc oxide and calcium hydroxide. Downstream thereafter, magnesium hydroxide and acetic acid can be added for reaction. Conversion and mixing can then take place in modules 12,13, 14 before the premix is fed in module 15 and/or module 16. The temperature control (see Table 2) leads to melting of the fatty acids. The fatty acids react to form soaps or salts of the corresponding acids, the reaction of which is or will be completed by module 13. In the present example, the premix is fed in module 15, and module 16 is used for tempering in preparation for subsequent underwater pelletizing.

After mixing the premix in module 15 with the further components of the stabilizer composition already present in this module 15, a stabilizer composition is discharged at the second end 3, which can be pressurized by a pump in the direction of a downstream perforated plate so that the stabilizer composition is pressed through the perforated plate and cutting to length can take place. A corresponding pelletizing can take place under water, for example, but also in air. Pelletized stabilizer is then obtained, which contains impact modifiers and can be admixed to a dry blend as a completely finished stabilizer composition, but can also be used for direct production of a profile from a polymer, in particular a profile made of PVC. The resulting stabilizer product containing an impact modifier is designated P1.

For comparison, all components 1 to 4 from Table 3 were reacted in a conventional batch method in a reactor, and after the reaction was completed to give the corresponding soaps or salts, components A to G were added to the melt in a suitable order and the comparative product V1 was formed as a tablet.

The comparison of the product P1 according to the invention with the reference product produced by conventional batch methods without possible incorporation of impact modifier is given in Table 5.

In each case, a dry blend is produced with PVC and further filler, and the respective dry blend is extruded to form profile specimens. These profile specimens were subjected to an impact test. The higher impact energy value of the specimen produced according to the invention shows the unexpected advantage.

TABLE 5
Composition of extruded profile samples

| Component | P1 | V1 |
|---|---|---|
| PVC [g] | 100 | 100 |
| Filler (chalk) [g] | 15 | 15 |
| Pigment (titanium dioxide) [g] | 4 | 4 |
| P1 [g] | 10 | |
| V1 [g] | | 4 |
| Impact modifier (Component H, Table 4) [g] | | 6 |
| Total [g] | 129 | 129 |
| Double V Notch [kJ/m²] | 17.5 (+/−1.5) | 10.5 (+/−1.1) |

Various test series have shown that the quality of a prepared stabilizer composition, which immediately has an impact modifier admixed, can be achieved by a specific adjustment of the shear forces. By using a planetary roller extruder 1, it is possible to optimize the shear forces during producing via the rotational speed of the spindle 4 as well as a number of planetary spindles in such a way that the best possible mixing or homogenization takes place for the individual components. This applies in particular to the impact modifier, which is admixed or fed to the stabilizer composition only at a relatively late stage, namely in the last third or at most the last module 16. A smaller number of planetary spindles means lower shear forces, so that undesirable gelation or speck formation is prevented and a high quality stabilizer composition can be obtained.

1. A method for producing a stabilizer composition for a polymer, in particular a polymer containing halogen such as polyvinyl chloride, wherein components for forming the stabilizer composition are mixed in an extruder and continuously discharged therefrom, and wherein an impact modifier is admixed, wherein a planetary roller extruder is used as extruder and the extrusion is carried out with downstream decreasing shear forces.

2. The method according to claim 1, wherein an acrylate is admixed as an impact modifier.

3. The method according to claim 1, wherein the impact modifier is admixed downstream in a last third of the extruder as viewed in the extrusion direction.

4. The method according to claim 1, wherein an extruder having a plurality of sections arranged in series is used and the impact modifier is admixed in a last section.

5. (canceled)

6. The method according to claim 1, wherein the impact modifier is admixed as the last component.

7. The method according to claim 1, wherein the stabilizer composition is pelletized after discharge from the extruder.

8. The method according to claim 6, wherein the stabilizer composition is pelletized in air.

9. The method according to claim 6, wherein the stabilizer composition is pressurized after the extruder for pelletizing.

10. The method according to claim 1, wherein a planetary roller extruder with several modules, preferably at least three modules, in particular four to eight modules, is used.

11. The method according to claim 1, wherein the components are extruded in a temperature range of about 80° C. to 240° C.

12. The method according to claim 1, wherein along the planetary roller extruder downstream, the temperature is initially set to increase and then to decrease again.

13. The method according to claim 1, characterized in that the shear forces in the planetary roller extruder are adjusted to decrease downstream, in particular by reducing a number of the planetary rollers in the planetary roller extruder downstream.

14. A stabilizer composition obtainable according to claim 1.

15. A method using a planetary roller extruder for producing a stabilizer composition, wherein shear forces are adjusted via a different number of planetary spindles in modules of the planetary roller extruder.

16. The method according to claim 1, wherein a planetary roller extruder is used as extruder.
